(19) United States
(12) Patent Application Publication
(10) Pub. No.: US 2010/0206152 A1
(43) Pub. Date: Aug. 19, 2010

(54) SHEET PUNCH DEVICES

(75) Inventor: Wan-Young OH, Seoul (KR)

Correspondence Address: STEIN MCEWEN, LLP, 1400 EYE STREET, NW, SUITE 300, WASHINGTON, DC, 20005, US

(73) Assignee: DN Craft Corporation of Seoul, Seoul (KR)

(21) Appl. No.: 12/372,237

(22) Filed: Feb. 17, 2009

(51) Int. Cl. B26F 1/14

(52) U.S. Cl. 83/687

(57) ABSTRACT

A sheet punch device comprises: a lower base providing a reference plane on which a sheet material is placed; a jig installed on the lower base to have a pattern hole for punching a sheet material; and a punching unit including a punching block sliding up and down to pass through the pattern hole of the jig to thereby punch the sheet material; wherein the punching unit is hinged to the lower base at one end to fully pivot to provide an open space above the lower base.

### BACKGROUND OF THE INVENTION

1. Field of the Invention

The present invention relates to a sheet punch device for punching a sheet material such as paper, letters and cards, more particularly to a sheet punch device adopting means for guiding rectangular corner edges of the sheet for punching various kinds of pattern on the sheet.

Also, the present invention pertains to a sheet punch device which enables a user to see the sheet with open space above the sheet for alignment.

2. Description of the Related Art

In general, a punch device has a jig formed with a predetermined pattern hole and a punching block having a sharp cutting blade passing through the pattern hole to punch the same pattern as the pattern hole on a sheet such as paper.

A typical punch device shown in FIG. 1 comprises a jig 1 formed with a pattern hole, a base 2 supporting the jig 1, a punching block 3 passing through the pattern hole for punching a sheet, and a press member 4 for pressing the punching block 3.

Here, the jig 1 comprises an upper guide plate 5 formed with a guide hole, and a lower punching plate 6 formed with a pattern hole, which are spaced from to face each other.

The guide hole and the pattern hole should be aligned with high precision when punching the sheet therebetween by the punching block 3, which is why the jig 1 has the above described configuration.

In doing so, the guide plate 5 and the punching plate 6 are integrally formed by injection molding, and then separated by cutting off the gap between the guide plate 5 and the punching plate 6 with a connection portion therebetween partially left.

With the above punch device, the sheet has a limitation in depth by which the sheet inserts into the gap because a side edge of the sheet abuts against the partial connection portion of the guide plate 5 and the punching plate 6 to thereby stop. Accordingly, the sheet is punched in not the area around the center of the sheet, but only the area adjacent to edges thereof.

Also, it makes difficult for a user to see the sheet inserted into the jig for alignment because the jig 1 covers the sheet.

Another problem of the prior art is that a sheet or a stack of paper having a thickness lager than the gap between the guide plate 5 and the punching plate 6 shall not be punched because the gap is fixed predetermined value.

To solve the above problems, a sheet punch device in FIG. 2 comprises a guide plate and a punching plate which are separated from each other.

That is, a guide plate 13 having a guide hole 12 through which a punching block 11 slides is provided on an upper punching unit 14, while a lower punching plate 16 having a pattern hole 15 of the same pattern as the guide hole 12 is provided on a base 17.

The punching unit 14 is attached to the base 17 by a plurality of magnets 18 and 19 installed on the lower surface of the punching unit 14 and the upper surface of the base, respectively.

The sheet punch device enables punching the sheet at the center as well as at edges of the sheet because the sheet is not prevented from inserting into the jig.

However, the sheet punch device has a disadvantage that misalignment of the sheet with the jig is severe because of attachment of the punching unit 14 and the base 17 by the magnets, which makes it difficult to punch the sheet precisely with various patterns.

Also, pattern marks 20 having at least a portion of shape of the pattern hole 15 are provided on the upper surface of the base 17 as shown FIG. 2. Accordingly, a user is able to obtain works in the form of circular or polygonal shape by punching the sheet repeatedly with a punched pattern aligned with the pattern marks 20.

In the conventional sheet punch device of FIG. 2, the sheet is punched with patterns while being rotated about one of central points 21. That is, a rotational point of the sheet is limited to a single point, which does not provide a diversity of choosing the rotational point for various patterns.

Furthermore, the pattern is completed by rotating the sheet only in one direction, i.e., clockwise or counterclockwise directions, so that the pattern marks 20 should be formed in the circular direction for guiding the rotation of the sheet.

Meantime, most sheets have rectangular corner edges on which two sides of the sheet meet at 90° each other (hereinafter referred as ‘rectangular corner edges’). In spite of that, the conventional sheet punch device does not provide means for punching the sheet with various patterns by guiding the rectangular corner edges of the sheet.

### SUMMARY OF THE INVENTION

The present invention is designed to solve the above problems of the prior art. It is an object of the invention to provide a sheet punch device by which various kinds of patterns may be obtained according to user's desire by guiding just rectangular corner edges of a sheet material.

Another object of the invention is to provide a sheet punch device which enables a user to see a punching position of the sheet material by connecting a punching unit to a base with a hinge to pivot fully to open state.

Still another object of the invention is to provide a sheet punch device capable of punching a sheet material having a relatively large thickness such as cardboards, art paper or a stack of paper.

Further another object of the invention is to provide a sheet punch device in which the insertion of a sheet material with respect to a jig is not restricted while minimizing the misalignment of a punching block and a punching plate.

In order to the above objects, the present invention provides a sheet punch device comprising: a lower base providing a reference plane on which a sheet material is placed; a jig installed on the lower base to have a pattern hole for punching a sheet material; and a punching unit including a punching block sliding up and down to pass through the pattern hole of the jig to thereby punch the sheet material; wherein the punching unit is hinged to the lower base at one end to fully pivot to provide an open space above the lower base.

Preferably, the sheet punch device further comprises a hinge bush provided at one end of the lower base, the hinge bush having a slot; and a hinge protrusion provided on the punching unit to be inserted into the slot; wherein the hinge protrusion is prevented from moving back and forth except for the movement in the vertical direction in the slot.

According to another aspect of the present invention, there is provided a sheet punch device comprising: a lower base providing a reference plane on which a sheet material is placed; a jig installed on the lower base to have a pattern hole for punching a sheet material; a punching unit including a punching block sliding up and down to pass through the pattern hole of the jig to thereby punch the sheet material; and means for guiding rectangular corner edges of the sheet material placed on the lower base.

According to still another aspect of the present invention, there is provided a sheet punch device comprising: a lower base providing a reference plane on which a sheet material is placed; a jig installed on the lower base to have a pattern hole for punching a sheet material; and a punching unit including a punching block sliding up and down to pass through the pattern hole of the jig to thereby punch the sheet material; wherein pattern marks are provided on the lower base to have at least the same pattern as the pattern hole, the pattern marks being angled at 90° with respect to the pattern of the pattern hole.

According to further another aspect of the present invention, there is provided a sheet punch device comprising: a lower base providing a reference plane on which a sheet material is placed; a jig installed on the lower base to have a pattern hole for punching a sheet material; and a punching unit including a punching block sliding up and down to pass through the pattern hole of the jig to thereby punch the sheet material; wherein pattern marks are provided on the lower base to have at least the same pattern as the pattern hole, the pattern marks being angled at 180° with respect to the pattern of the pattern hole.

According to the present invention, the sheet material may be punched with various kinds of patterns as user's desire because it is guided at rectangular corner edges.

Also, the punching unit pivots upon the lower base to provide an open space above the lower base, which enables a user to see the sheet material and the punched pattern during punching.

In addition, the sheet punch device of the invention is able to punch a sheet material having a relatively large thickness due to adjustment of the gap between the punching unit and the lower base.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which.

FIG. 1 is an exploded perspective view showing the conventional sheet punch device.

FIG. 2 is a perspective view showing another conventional sheet punch device.

FIG. 3 is a perspective view showing a sheet punching device according to a preferred embodiment of the present invention;

FIG. 4 is an exploded perspective view showing a sheet punch device according to a preferred embodiment of the present invention;

FIG. 5 is a perspective view showing a sheet punching device according to a preferred embodiment of the present invention;

FIG. 6 is a perspective view showing an operation of a sheet punching device according to a preferred embodiment of the present invention;

FIG. 7 is a plan view showing a lower base of a sheet punching device according to a preferred embodiment of the present invention;

FIGS. 8 through 17 are plan views schematically showing examples of punching a sheet material according to the preferred embodiment of the present invention; and

FIG. 18 is a plan view showing a jig of a sheet punch device according to the preferred embodiment of the present invention.

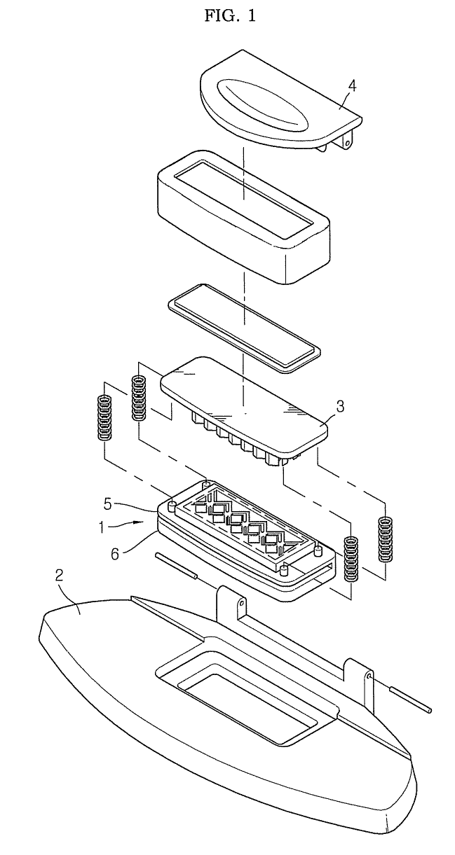

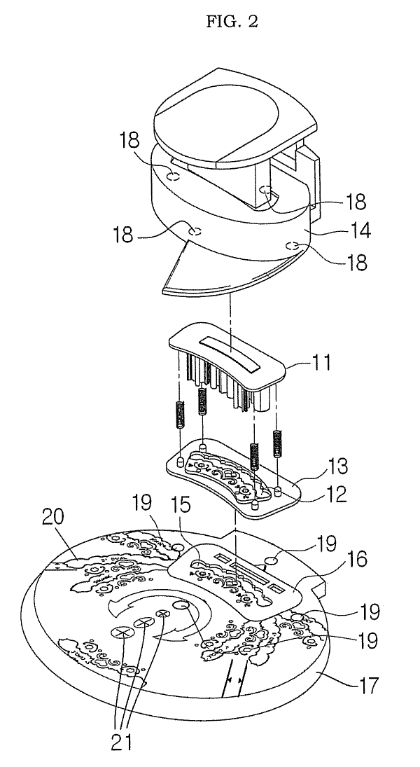

### DETAILED DESCRIPTION OF THE EMBODIMENTS

Hereinafter, preferred embodiments of the present invention will be described in detail with reference to the accompanying drawings. However, it should be understood that the terms in the description and the appended claims should not be construed as limited to general and dictionary meanings, but interpreted based on the meanings and concepts corresponding to technical aspects of the present invention on the basis of the principal that the inventor is allowed to define terms appropriately as a lexicographer.

Therefore, the embodiments herein are just preferable examples for the purpose of illustrating the invention, not intended to limit the scope of the invention, so it should be under stood that other equivalents and modifications could be made thereto without departing from the spirit and scope of the invention.

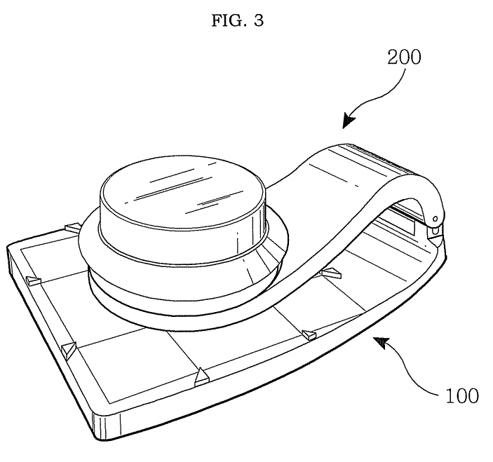

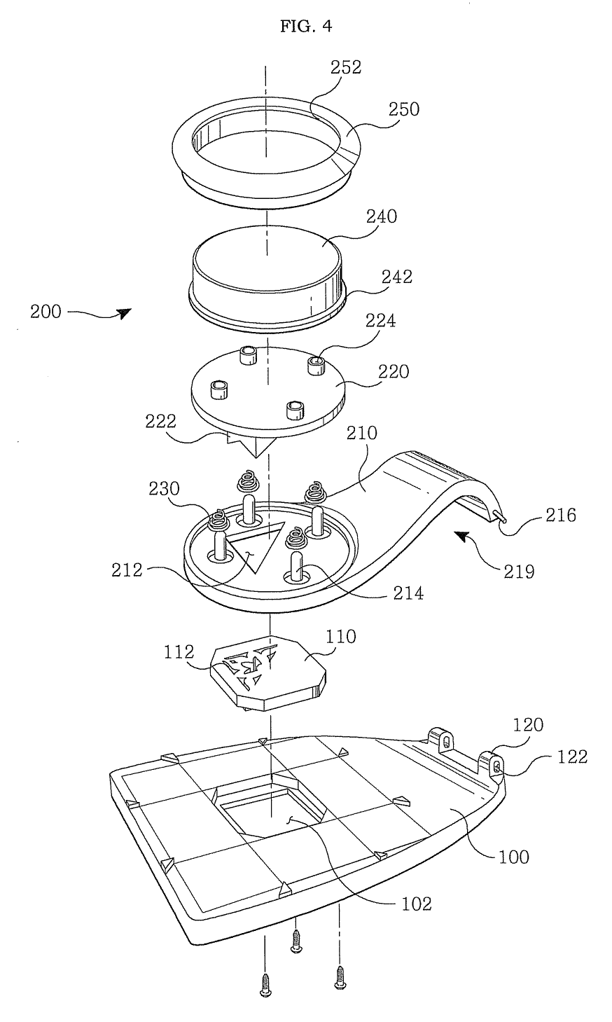

FIGS. 3 and 5 show a sheet punch device according to a preferred embodiment of the present invention. The punch device of the present invention may punch a sheet having a relatively large thickness such as cardboards, art papers or a stack of papers (hereinafter referred as ‘a sheet material’).

Referring to the drawings, the sheet punch device of the present invention comprises a lower base 100 providing a flat plane on which a sheet material is placed, and a punching unit 200 pivotally connected with the lower base 100 at one end for punching the sheet material.

The lower base 100 has a flat plan on which the sheet material is placed on the top, and a recess 102 formed on the upper surface thereof.

A jig 110 having a pattern hole 112 of a predetermined shape rests on the recess 102.

More preferably, the recess 102 is slightly larger than the jig 110 so that the jig 110 move laterally to a short distance, which facilitate the alignment of the cutting blade with respect to the pattern hole 112 when punching the sheet material as set forth later.

The punching unit 200 comprises an upper body 210 hinged to the lower base 100, and the upper body 210 contains a punching block 220 therein. An opening 212 is formed on the upper body 210.

The punching block 220 slides up and down through the pattern hole 112 of the jig 110 to punch the sheet material. The punching block 220 has a cutting blade 222 having a shape corresponding to the pattern hole 112 on the lower surface of the punching block 220 to insert into the pattern hole 112 of the jig 110 by passing through the opening 212.

The punching block 220 is biased upward by an elastic force. In doing so, a plurality of elastic members 230 such as springs are installed between the upper body 210 and the punching block 220 to elastically force the punching block 220 upward.

A plurality of guides 214 are provided on the upper body 210 to guide the movement of the punching block 220 up and down. The guide 214 are inserted into guide holes 224 formed on the punching block 220, and more preferably, the guides 214 are shaped circular column to provide a stable guidance of the punching block 220.

The elastic members 230 are installed about the guides 214. The elastic members 230 are preferably coil spring in the shape of corn from the top so that the spring may be decreased in height when compressed.

In spite of the above description, the configuration of guiding the punching block 220 may have a various modifications, but not limited thereto.

A press member 240 is provided on the punching block 220 while being connected to the upper body 210 by a bracket 250 having a through hole at the center thereof.

Specifically, the press member 240 has a flange 242 on the circumferential surface at a lower end. The flange 242 connects to a stopper flange 252 formed on the inner surface of the bracket 250 at the top not to pop out when the press member 240 is inserted into the through hole of the bracket 250.

With the above alignment, the bracket 250 may be fixed to the upper body 210, for example, by a screw fitting, but not limited thereto.

Although not shown in the drawing, a guide plate having a guide pattern hole corresponding to the pattern 112 may be further provided on the lower base 100.

The punching unit 200 of the present invention may have a various modification in the scope of the invention including well known mechanism as well as those proposed by the inventors.

According to the present invention, the punching unit 200 is hinged to the lower base 100 at one end capable of pivoting upon the connection thereof. That is, the lower base 100 is provided with a hinge bush 120 having a slot 122 at an end, and the upper body 210 has a hinge protrusion 216 to be inserted into the slot 122 at an end.

Accordingly, the hinge protrusion 216 inserts into the slot 122, which enables the upper body 210 to pivot with respect to the lower base 100.

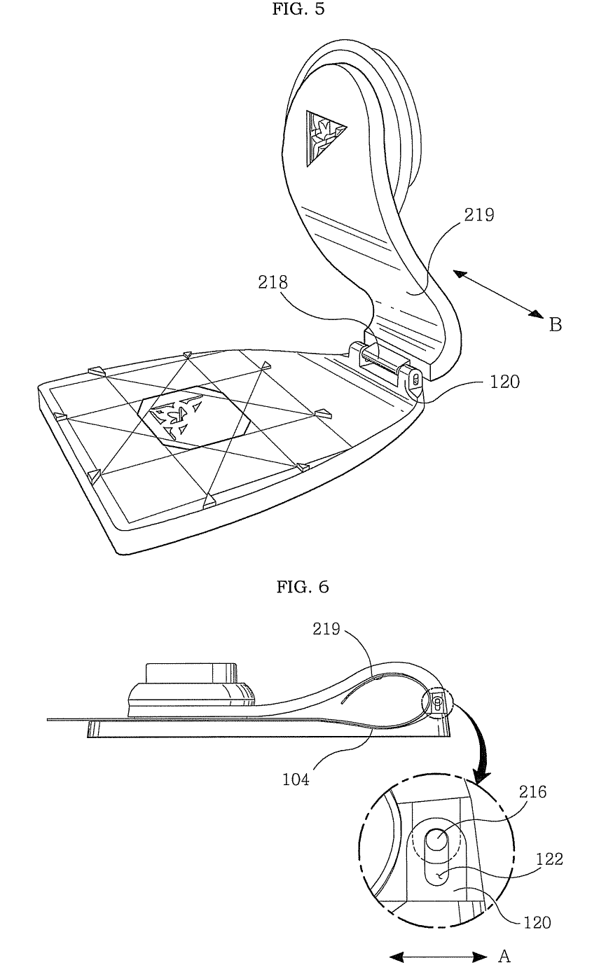

As shown in FIG. 6, the width of the slot 122 is substantially the same as that of the hinge protrusion 216, so that the hinge protrusion 216 is prevented from moving back and forth in the direction of arrow A except for the movement in the vertical direction in the slot 122.

Also, the upper body 210 has a spacer 218 having a length substantially the same as the distance between a pair of hinge bushes 120 and interposed between the pair of hinge bushes 120, so that the upper body 210 is refrained from moving laterally in the direction of arrow B in FIG. 5.

As a result, the hinge protrusion 216, i.e., the upper body 210 is able to move only up and down in the slot 122, i.e., with respect to the lower base 100, which makes it possible to adjust the gap between the upper body 210 and the lower base 100 depending on the thickness of the sheet material.

When a sheet material having a relatively large thickness is placed between the upper body 210 and the lower base 100, the hinge protrusion 216 moves up in the slot 122 by the distance of thickness of the sheet material. At this time, since the upper body 210 moves with respect to the lower base 100 vertically but not horizontally, the alignment of the upper body 210 and the lower base 100 for punching can be maintained.

According to the present invention, the upper body 210 may fully pivot with respect to the lower base 100 to provide an open space above the lower base 100 so that a user is able to see and align the sheet material without interference of the upper body 210.

Also, the upper body 210 has a concaved portion 219 on the inner surface, preferably at the position adjacent to the connection of the upper body 210 and the lower base 100.

The concaved portion 219 makes it easier to punch the center of the sheet material. Specifically, the sheet material is placed between the upper body 210 and the lower base 100 with the end side of sheet material wound in the space of the concaved portion 219 against the lower base 100 for punch the central area of the sheet material without folding or cutting the sheet material.

More preferably, as shown in FIG. 6, another concaved portion 104 may be formed on the lower base 100 to correspond to the concaved portion 219 of the upper body 210. The concaved portions 104 and 219 are contoured to have a curvature along the direction in which the sheet material is supplied.

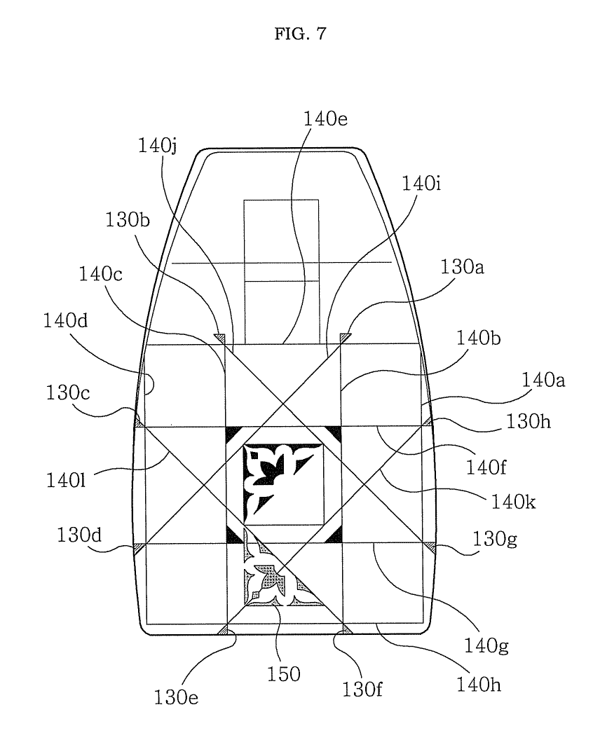

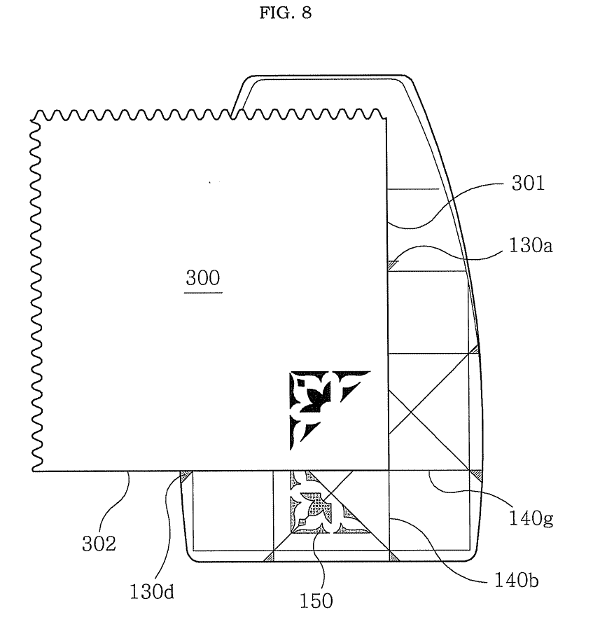

Referring to FIG. 7, the sheet punch device of the present invention comprises means for guiding the sheet material. The guiding means comprise a plurality of guide protrusions 130a through 130h to contact rectangular corner edges (see 301 and 302 of FIG. 8) of the sheet material.

Preferably, guide lines 140a through 140l are further provided between the guide protrusions 130a to 130h. The guide lines 140a to 140l may be formed in the form of printed lines, scores, protrusions or grooves, but not limited thereto. Also, the guide protrusions 130a to 130h may be printed instead of protrusions.

More preferably, the guide lines comprise vertical guide lines 140a to 140d, horizontal guide lines 140e to 140h, and slant guide lines 140i to 140l.

According to the present invention, the guiding means contact the rectangular corner edges 301 and 302 of a sheet material 300 of FIG. 8. The sheet material 300 may be punches with various kinds of patterns by rotating the sheet material to align the rectangular corner edges 301 and 302 with the guide protrusions 130a to 130h or the guide lines 140a to 140l as desired.

FIGS. 8 to 11 illustrate the operation of punching the sheet material with guidance of a pair of rectangular corner edges 301 and 302.

In the present embodiment, whenever the sheet material 300 is rotated at 90° or 180°, the rectangular corner edges 301 and 302 of the sheet material 300 are guided by the guide protrusions 130a to 130h in contact.

Referring to FIG. 8, one side edge 301 of the sheet material 300 is in contact with the guide protrusion 130a, while the other side edge 302 rectangular to the side edge 301 is in contact with the guide protrusion 130d.

More preferably, the rectangular corner edges 301 and 302 may be guided the guide lines 140b and 140g at the same time. With the alignment of the above, the sheet material 300 is punched as shown in FIG. 8.

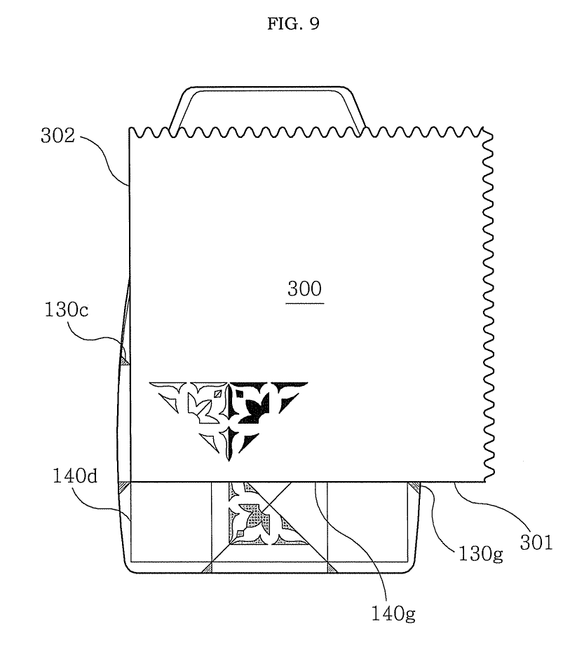

After the first punching of the sheet material, the sheet material 300 is rotated clockwise at 90°, as shown in FIG. 9, so that one side edge 301 of sheet material 300 aligns with the guide protrusion 130g and the guide line 140g, and the other side edge 302 aligns with the guide protrusion 130c and the guide line 140d.

More preferably, with the above alignment, the pattern hole 112 of the jig 110 is configured to be symmetrical to the punched pattern of the sheet 300. Next, the second punching of sheet material 300 is conducted by pressing the press member 240 as marked in black in FIG. 9.

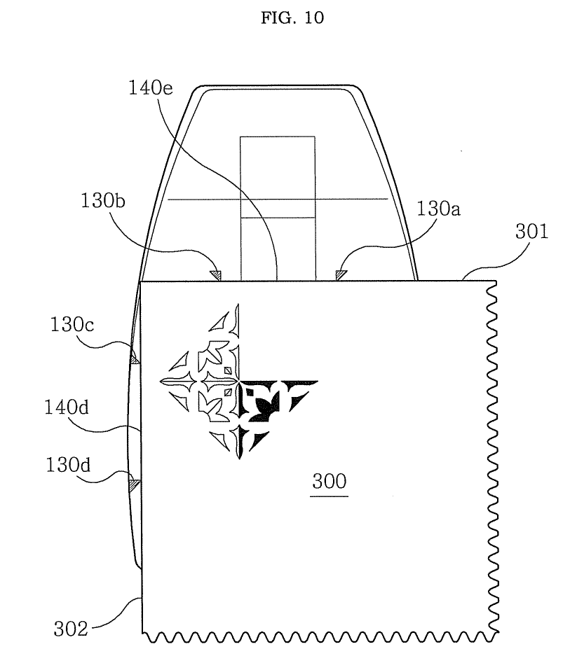

Subsequently, the sheet material 300 is rotated clockwise at 90° so that one side edge 301 of the sheet material 300 is guided by the guide protrusion 130a or 130b and the guide line 140e while the other side edge 302 is guided by guide protrusion 130c or 130d and the guide line 140d as shown in FIG. 10.

In this state, the pattern hole 112 of the jig 110 and the pattern punched shortly before on the sheet material 300 are symmetrical each other. Then, like the above the third punching of the sheet material 300 is conducted by pressing the press member 240 as marked in black.

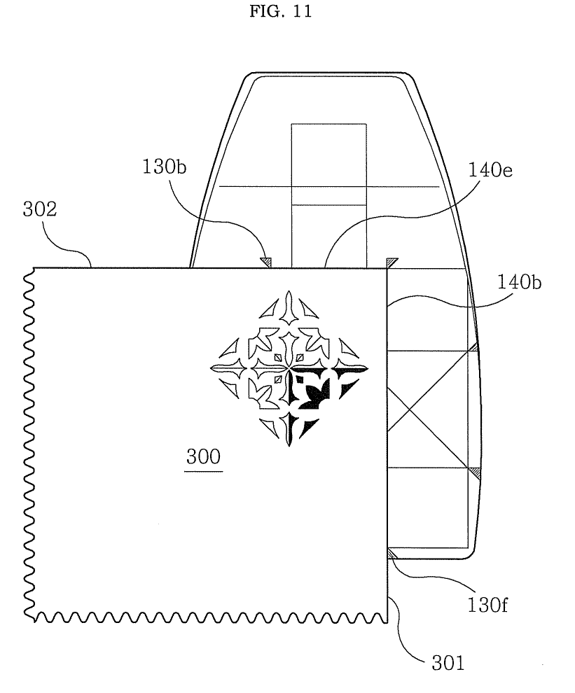

The sheet material 300 is rotated clockwise at 90° after punching as shown in FIG. 11. At this time, one side edge 301 of the sheet material 300 aligns with the guide protrusion 130f and the guide line 140b, and the other side edge 302 aligns with the guide protrusion 130b and the guide line 140e so that the pattern hole 112 of the jig 110 and the previously punched pattern of the sheet material 300 are symmetrical each other.

Then, the forth punching of the sheet material 300 is conducted as marked in black to result in the pattern as shown in FIG. 11.

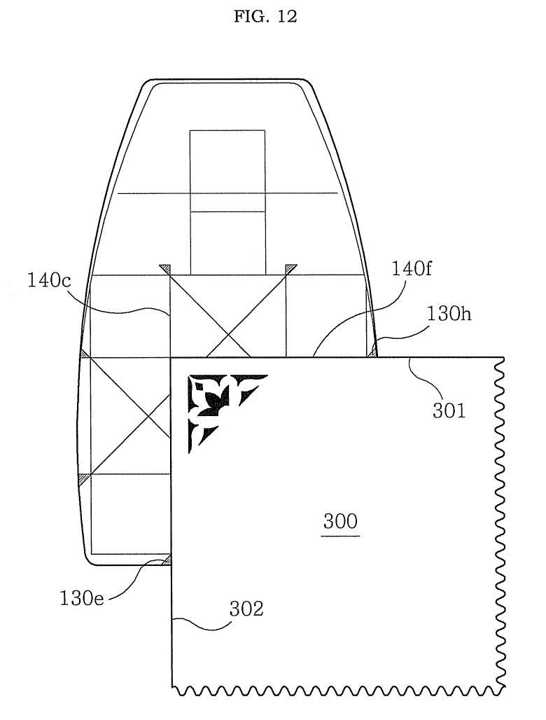

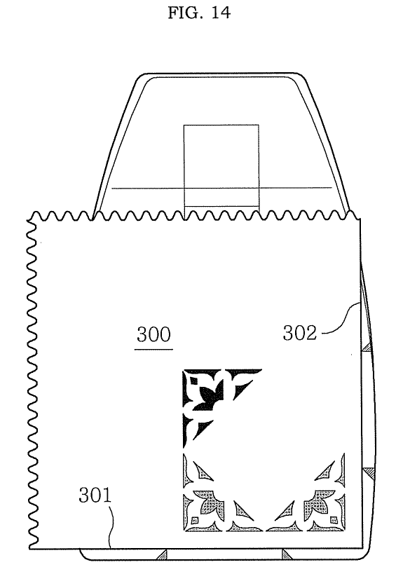

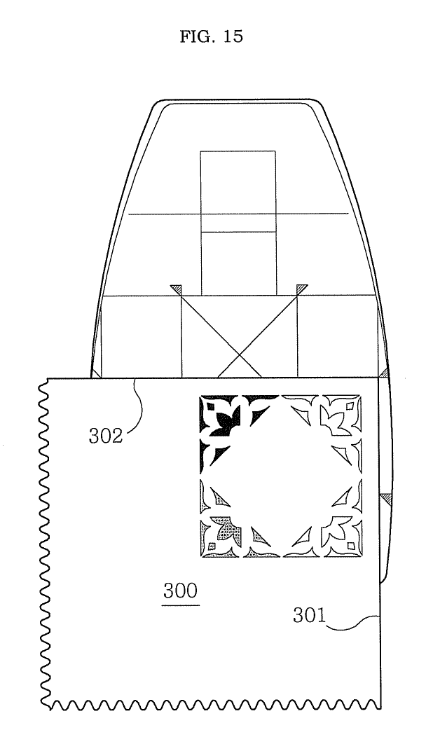

FIGS. 12 to 15 illustrate another example of punching the sheet material with guidance of a pair of rectangular corner edges 301 and 302.

In the present embodiment, the guide protrusions 130a to 130h guide the rectangular corner edges 301 and 302 of the sheet material 300 in contact upon each rotation of the sheet material 300 in the counterclockwise direction at 90°.

Also, the sheet material 300 may be aligned by pattern marks as well as the guide protrusions and lines.

Referring to FIG. 12, one side edge 301 of the sheet material 300 is in contact with the guide protrusion 130h and the guide line 140f, while the other side edge 302 is in contact with the guide protrusion 130e and the guide line 140c.

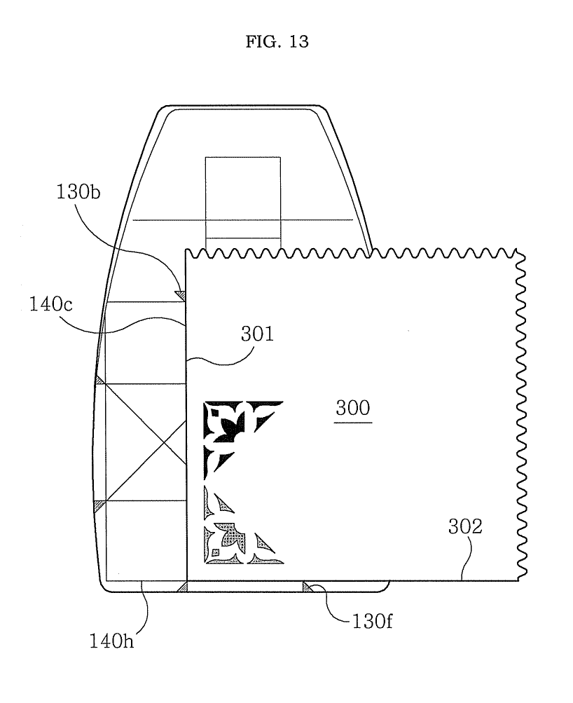

After the first punching of the sheet material, the sheet material 300 is rotated counterclockwise at 90°, as shown in FIG. 13, so that one side edge 301 of sheet material 300 aligns with the guide protrusion 130b and the guide line 140c, and the other side edge 302 aligns with the guide protrusion 130f and the guide line 140h.

Here, pattern marks 150 of FIG. 7 are printed on the lower base 100 to have at least the same pattern as the pattern hole 112 of the jig 110. Since the pattern marks 150 have the pattern angled at 90° with respect to the pattern of the pattern hole 112, the punched pattern of the sheet material 300 would overlap precisely with the pattern marks 150 by rotating the sheet material 300 by 90° counterclockwise.

Accordingly, as shown in FIGS. 13 to 15, the sheet material may be punched with symmetrical patterns by repeatedly punching and rotating the sheet material 300 counterclockwise at 90° with the punched pattern of the sheet material 300 and the pattern marks 150 overlapped.

According to the present invention, it is possible to punch the sheet material 300 with a pattern by rotating the sheet material 300 to align with the pattern marks 150 without the guide protrusions and lines, because the pattern marks 150 are angled at 900 with respect to the pattern of the pattern hole clockwise or counterclockwise.

Thus, a user punches any position of the sheet material 300 and rotates the same at 90° to align the punched pattern with the pattern marks 150 to thereby conduct subsequent punching without the use of the guide protrusions and lines.

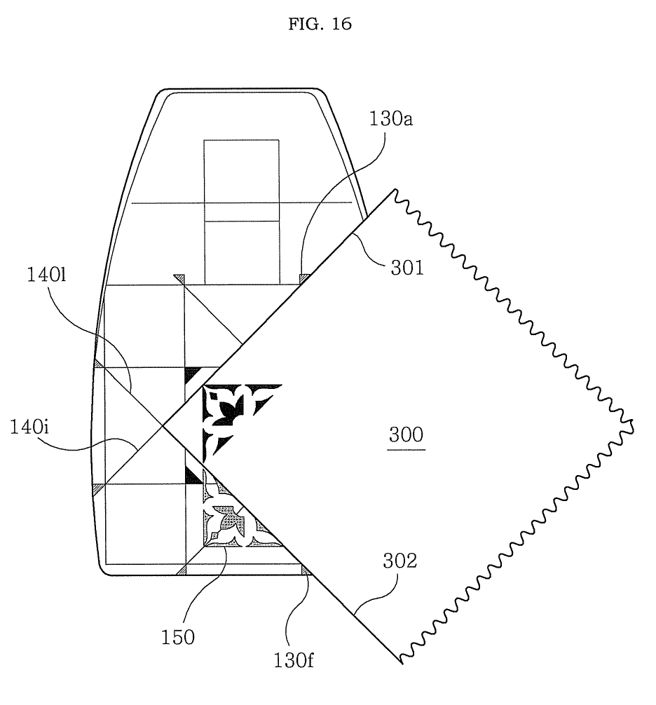

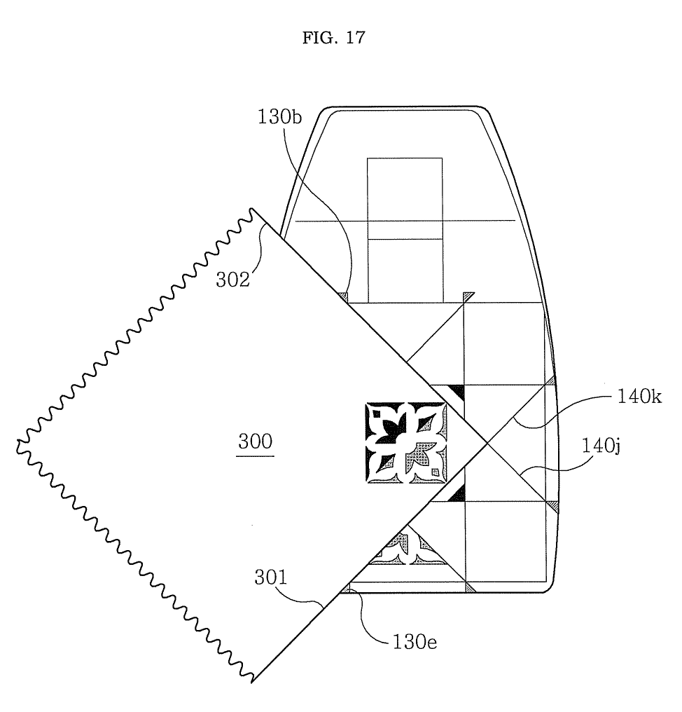

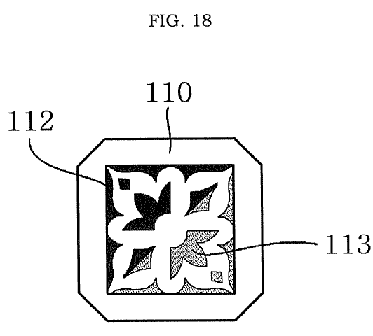

FIGS. 16 to 17 illustrate still another example of punching the sheet material with slant guide lines 149i to 140l.

In the present embodiment, the slant guide lines 140i to 140l guide the rectangular corner edges 301 and 302 of the sheet material 300 in contact upon each rotation of the sheet material 300 by 90°.

Referring to FIG. 16, one side edge 301 of the sheet material 300 is in contact with the guide protrusion 130a and the guide line 140i, while the other side edge 302 is in contact with the guide protrusion 130f and the guide line 140l.

After the first punching of the sheet material, the sheet material 300 is rotated by 180°, as shown in FIG. 17, so that one side edge 301 of sheet material 300 aligns with the guide protrusion 130e and the guide line 140k, and the other side edge 302 aligns with the guide protrusion 130b and the guide line 140j.

Preferably, the jig 110 has an embossment pattern 113 on the top surface, which has the same pattern as the pattern hole 112 to be angled at 180° with respect to the pattern hole 112. That is, the embossment pattern 113 and the pattern hole 112 are symmetrical at 180° each other.

The embossment pattern 113 may be formed during the injection molding for jig 110.

The embossment pattern 113 makes it easier for a user to align the sheet material 300 for subsequent punching by rotating the sheet material 300 by 180° such that the previously punched pattern of the sheet material 300 overlaps with the embossment pattern 113.

Accordingly, the sheet material 300 may be punched with symmetrical patterns of 180° as a result of second punching.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A sheet punch device comprising:
a lower base providing a flat plane on which a sheet material is placed;
a jig installed on the lower base to have a pattern hole for punching a sheet material; and
a punching unit including a punching block sliding up and down to pass through the pattern hole of the jig to thereby punch the sheet material;
wherein the punching unit is hinged to the lower base at one end to fully pivot to provide an open space above the lower base.

2. The sheet punch device according to claim 1, further comprising:
a hinge bush provided at one end of the lower base, the hinge bush having a slot; and
a hinge protrusion provided on the punching unit to be inserted into the slot;
wherein the hinge protrusion is prevented from moving back and forth except for the movement in the vertical direction in the slot.

3. The sheet punch device according to claim 2, further comprising:
a spacer interposed between a pair of hinge bushes to refrain the punching unit from moving laterally.

4. The sheet punch device according to claim 1, further comprising:
a concaved portion formed on the inner surface of at least one of the punching unit and the lower base so that the sheet material is placed between the punching unit and the lower base with the end side of sheet material wound in the space of the concaved portion

5. A sheet punch device comprising:
a lower base providing a flat plane on which a sheet material is placed;
a jig installed on the lower base to have a pattern hole for punching a sheet material;
a punching unit including a punching block sliding up and down to pass through the pattern hole of the jig to thereby punch the sheet material; and
means for guiding rectangular corner edges of the sheet material placed on the lower base.

6. The sheet punch device according to claim 5, wherein the guiding means are configured to guide the rectangular corner edges of the sheet material upon each rotation of the sheet material by 90° on the lower base.

7. The sheet punch device according to claim 6, wherein the guiding means comprise a plurality of guide protrusions.

8. The sheet punch device according to claim 7, wherein the guiding means further comprise a plurality of guide lines formed between the guide protrusions.

9. The sheet punch device according to claim 8, wherein the guide lines comprise vertical guide lines, horizontal guide lines and slant guide lines.

10. The sheet punch device according to claim 5, wherein the guiding means are configured to guide the rectangular corner edges of the sheet material upon each rotation of the sheet material by 180° on the lower base.

11. The sheet punch device according to claim 10, wherein the jig further comprises an embossment pattern on the top surface, the embossment pattern having the same pattern as the pattern hole to be angled at 180° with respect to the pattern hole.

12. A sheet punch device comprising:
a lower base providing a flat plane on which a sheet material is placed;
a jig installed on the lower base to have a pattern hole for punching a sheet material; and
a punching unit including a punching block sliding up and down to pass through the pattern hole of the jig to thereby punch the sheet material;
wherein pattern marks are provided on the lower base to have at least the same pattern as the pattern hole, the pattern marks being angled at 90° with respect to the pattern of the pattern hole.

13. A sheet punch device comprising:
a lower base providing a flat plane on which a sheet material is placed;
a jig installed on the lower base to have a pattern hole for punching a sheet material; and
a punching unit including a punching block sliding up and down to pass through the pattern hole of the jig to thereby punch the sheet material;
wherein pattern marks are provided on the lower base to have at least the same pattern as the pattern hole, the pattern marks being angled at 180° with respect to the pattern of the pattern hole.
